(19) United States
(12) Patent Application Publication
(10) Pub. No.: US 2026/0043460 A1
(43) Pub. Date: Feb. 12, 2026

(54) ACTUATOR

(71) Applicant: SUMITOMO HEAVY INDUSTRIES, LTD., Tokyo (JP)

(72) Inventors: Takao SHIGEMI, Kanagawa (JP); Koji MORITANI, Kanagawa (JP)

(21) Appl. No.: 18/795,257

(22) Filed: Aug. 6, 2024

(51) Int. Cl. F16H 19/08; F16D 55/224; F16D 65/18; F16D 121/20; F16H 57/02; F16H 57/04

(52) U.S. Cl. CPC F16H 19/08; F16D 55/224; F16D 65/186; F16H 57/02; F16H 57/0415; F16D 2121/20; F16H 2057/02034; F16H 2057/02073

(57) ABSTRACT

An actuator includes a motor and a speed reducer that are connected to each other, in which a heat transfer member having elasticity is disposed between a coil end of the motor and a speed reducer casing of the speed reducer.

### BACKGROUND

### Technical Field

Certain embodiments of the present invention relate to an actuator.

### Description of Related Art

In the related art, an actuator including a motor and a speed reducer is known (see, for example, the related art).

In this type of actuator, heat generation from the motor is an issue. For the motor alone, a method of dissipating heat from a casing (housing) by providing heat dissipation fins on the casing is generally used, but there is room for improvement in cooling performance (heat dissipation) of the motor.

### SUMMARY

According to an embodiment of the present invention, there is provided an actuator including a motor and a speed reducer that are connected to each other, in which a heat transfer member having elasticity is disposed between a coil end of the motor and a speed reducer casing of the speed reducer.

### BRIEF DESCRIPTION OF THE DRAWINGS

FIG. 1 is a cross-sectional view showing an actuator according to one embodiment.

FIG. 2 is an enlarged view of a periphery of a motor in FIG. 1.

FIG. 3 is a cross-sectional view showing an actuator according to another embodiment.

### DETAILED DESCRIPTION

It is desirable to improve heat dissipation of a motor.

Hereinafter, embodiments of the present invention will be described in detail with reference to the drawings.

### One Embodiment

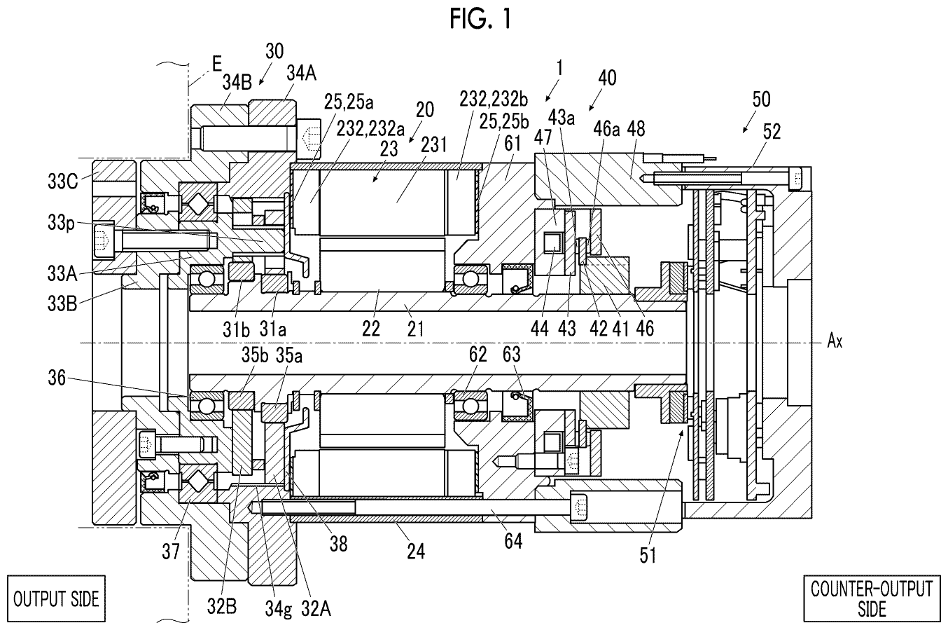

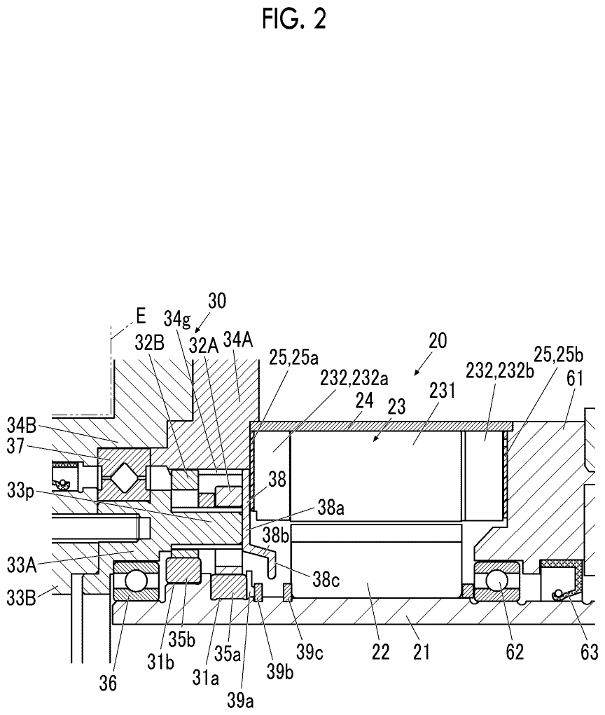

FIG. 1 is a cross-sectional view showing an actuator 1 according to one embodiment of the present invention, and FIG. 2 is an enlarged view of a periphery of a motor 20 in FIG. 1.

As shown in FIG. 1, the actuator 1 according to one embodiment includes the motor 20, a speed reducer 30, a brake 40, and a circuit section 50. The use of the actuator 1 is not particularly limited, but the actuator 1 may be incorporated into, for example, a joint portion of an industrial robot, a cooperative robot, or a service robot.

In the following description, a direction along a center axis Ax of the actuator 1 is referred to as an “axial direction”, a direction perpendicular to the center axis Ax is referred to as a “radial direction”, and a rotation direction around the center axis Ax is referred to as a “circumferential direction”. In addition, in the axial direction, a side connected to a driven member (not shown) (left side in the drawing) is referred to as an “output side (load side)”, and a side opposite to the output side (right side in the drawing) is referred to as a “counter-output side (counter-load side)”.

### Configuration of Motor

The motor 20 includes a rotary shaft 21, a motor rotor 22, a motor stator 23, and a motor casing 24.

The rotary shaft 21 extends from the speed reducer 30 to the brake 40 so as to penetrate a center thereof, and is rotatably supported about the center axis Ax.

The motor rotor 22 is fixed to an outer peripheral surface of the rotary shaft 21 and rotates integrally with the rotary shaft 21. The motor rotor 22 has a permanent magnet such as a neodymium magnet on its outer peripheral surface.

The motor stator 23 is configured by winding a coil around a stator core 231 made of, for example, laminated steel plates. The motor stator 23 is disposed concentrically on an outer peripheral side of the motor rotor 22. Coil ends 232 where the coil wound around the stator core 231 is exposed protrude from both sides of the motor stator 23 in the axial direction. The entire coil end 232 is molded with resin.

Heat transfer members 25 having elasticity are respectively interposed between a coil end 232a on the output side and a first speed reducer casing 34A of the speed reducer 30, and between a coil end 232b on the counter-output side and a cover member 61. A contact state of the heat transfer member 25 will be described in detail below.

The motor casing 24 covers the outer peripheral side of the motor rotor 22 and the motor stator 23, and the motor stator 23 is fitted into an inner peripheral surface of the motor casing 24. In addition, the motor casing 24 is formed of aluminum primarily for the purposes of weight saving and improved cooling performance, although this is not particularly limited.

A type of the motor 20 is not particularly limited, and for example, the motor 20 may be an induction motor instead of a permanent magnet type.

### Configuration of Speed Reducer

The speed reducer 30 is a center crank type eccentric oscillating speed reducer and is disposed on the output side of the motor 20. Specifically, the speed reducer 30 includes a plurality of (two) eccentric bodies 31a and 31b, external gears 32A and 32B, first to third output shafts 33A to 33C, the first speed reducer casing 34A, and a second speed reducer casing 34B.

The eccentric bodies 31a and 31b are provided on the outer peripheral surface of the rotary shaft 21. In the present embodiment, the rotary shaft 21 serves as both an output shaft of the motor and an input shaft of the speed reducer, but the output shaft of the motor and the input shaft of the speed reducer may be separate and connected to each other.

The external gears 32A and 32B have a plurality of inner pin holes provided circumferentially spaced apart at positions offset from the center axis Ax, and a central through-hole into which the rotary shaft 21 is inserted. The external gears 32A and 32B are rotatably supported with respect to the eccentric bodies 31a and 31b by eccentric body bearings 35a and 35b disposed between the external gears 32A and 32B and the eccentric bodies 31a and 31b, respectively, and oscillate with the rotation of the eccentric bodies 31a and 31b.

The first output shaft 33A is disposed on the outer peripheral side of the rotary shaft 21 and on the output side of the external gears 32A and 32B. The second output shaft 33B is disposed on the output side of the first output shaft 33A, and the third output shaft 33C is disposed on the output side of the second output shaft 33B. The first to third output shafts 33A to 33C are fixed to each other and are fixed to a driven member (for example, an arm member on a tip end side of a robot) (not shown). The first output shaft 33A rotatably supports the rotary shaft 21 via a bearing 36 disposed between the first output shaft 33A and the rotary shaft 21. The first output shaft 33A includes a plurality of inner pins 33p formed to bulge in a pin shape toward the counter-output side. The inner pin 33p is inserted into the inner pin holes of the external gears 32A and 32B. A retaining plate 38 that restricts movement of the external gear 32A to the counter-output side is disposed on the counter-output side of the inner pin 33p. In addition, an inner roller is rotatably fitted onto the inner pin 33p to promote sliding with the inner pin hole of the external gear 32, and the retaining plate 38 also restricts movement of the inner roller to the counter-output side.

As shown in FIG. 2, the retaining plate 38 includes a disk portion 38a disposed perpendicularly to the axial direction, a tubular portion 38b extending from an inner peripheral end of the disk portion 38a to the counter-output side, and an extension portion 38c extending from an end of the tubular portion 38b on the counter-output side to the inner peripheral side. An outer periphery of the disk portion 38a is held (or fitted) in the first speed reducer casing 34A, and a surface of the disk portion 38a on the counter-output side is substantially flush with a surface of the first speed reducer casing 34A. The tubular portion 38b has a tapered shape that gradually decreases in diameter from the output side toward the counter-output side. The extension portion 38c has an outer diameter larger than an outer diameter of a regulating member 39a and an inner diameter smaller than the outer diameter of the regulating member 39a. The regulating member 39a is fitted to the outer peripheral surface of the rotary shaft 21 at a side portion of the eccentric body bearing 35a on the counter-output side, and restricts movement of the eccentric body bearing 35a to the counter-output side. A first retaining ring 39b fitted into a circumferential groove of the rotary shaft 21 is disposed on a side portion of the regulating member 39a on the counter-output side. A second retaining ring 39c fitted into the circumferential groove of the rotary shaft 21 is disposed on an axially opposite side of the first retaining ring 39b across the extension portion 38c.

The tubular portion 38b and the extension portion 38c of the retaining plate 38, the regulating member 39a, the first retaining ring 39b, the second retaining ring 39c, and the rotary shaft 21 constitute a labyrinth seal. Accordingly, as compared with a case where an oil seal is provided in this portion, the motor 20 and the speed reducer 30 can be appropriately sealed with a compact and low-loss configuration, and leakage of a lubricant in the speed reducer 30 can be suppressed.

As shown in FIG. 1, the first speed reducer casing 34A is disposed on the outer peripheral side of the external gears 32A and 32B and the retaining plate 38. An internal gear 34g is provided on an inner peripheral portion of the first speed reducer casing 34A. The internal gear 34g includes a plurality of outer pins serving as internal teeth, and meshes internally with the external gears 32A and 32B.

The second speed reducer casing 34B is disposed on the outer peripheral side of the first output shaft 33A and the second output shaft 33B. The second speed reducer casing 34B rotatably supports the first output shaft 33A via a main bearing 37 disposed between the second speed reducer casing 34B and the first output shaft 33A. The second speed reducer casing 34B is fixed to the first speed reducer casing 34A. In addition, the second speed reducer casing 34B is fixed to a mating member E (for example, an arm member on a base end side of a robot).

With such a configuration, in the speed reducer 30, the eccentric bodies 31a and 31b rotate inside the external gears 32A and 32B in association with the rotation of the rotary shaft 21 output from the motor 20, whereby the external gears 32A and 32B oscillate in different phases. External teeth of the external gears 32A and 32B, which are farthest from the center axis Ax, mesh with the internal gear 34g due to the oscillation, and the meshing position changes in the circumferential direction with the oscillation. Specifically, each time the rotary shaft 21 makes one rotation, the meshing position between the internal gear 34g and the external gears 32A and 32B makes one revolution in the circumferential direction. There is a difference in number of teeth between the external gears 32A and 32B and the internal gear 34g, and each time the meshing position with the internal gear 34g makes one revolution, the external gears 32A and 32B rotate by the aforementioned difference in number of teeth. The rotation is transmitted to the first to third output shafts 33A to 33C via the inner pin 33p. Accordingly, the rotating motion of the rotary shaft 21 is decelerated and the rotary shaft 21 is extracted from the driven member connected to the third output shaft 33C.

### Configuration of Brake

The brake 40 is disposed on the counter-output side with respect to the motor 20. The brake 40 of the present embodiment is a holding brake that holds the rotary shaft 21 in a stopped state, although this is not particularly limited.

The brake 40 includes a hub member 41, a rotor 42, an armature 43, an electromagnetic coil 44, a plate 46, a frame 47, and a brake casing 48.

The hub member 41 is fixed (connected by, for example, a key) to the rotary shaft 21 that extends from the motor 20 to an inside of the brake 40, and the rotor 42 is formed in a disk shape and is connected to the hub member 41 by a spline or the like. Therefore, the rotor 42 rotates integrally with the rotary shaft 21.

The armature 43 is disposed on the output side of the rotor 42 and is supported to be displaceable in the axial direction so as to come into contact with and separate from the rotor 42. On the other hand, the plate 46 is disposed on the counter-output side of the rotor 42 and is supported by the frame 47. Two friction materials (linings) 43a and 46a are fixed to surfaces of the armature 43 and the plate 46 that face the rotor 42 in the axial direction. Among these, one provided on the armature 43 is a movable friction material 43a, and one provided on the plate 46 is a fixed friction material 46a.

The electromagnetic coil 44 moves the armature 43 in the axial direction by a magnetic force generated by energization, and brings the movable friction material 43a into contact with and away from the rotor 42.

The frame 47 is supported by the brake casing 48 and holds the electromagnetic coil 44, the plate 46, and the like.

The brake casing 48 is fixed to the cover member 61.

The cover member 61 is disposed between the brake 40 and the motor 20. A bearing 62 that rotatably supports the rotary shaft 21 and an oil seal 63 that seals a space between the motor 20 and the brake 40 are disposed in an inner peripheral portion of the cover member 61. The cover member 61 is fastened together with the brake casing 48, the motor casing 24, and the first speed reducer casing 34A by a fastening screw 64.

In the brake 40 having the above-described configuration, a braking force (holding force) is applied to the rotary shaft 21 by sandwiching the rotor 42 between the armature 43 and the plate 46 via the friction materials 43a and 46a by the reaction of the electromagnetic coil 44. Conversely, the force with which the rotor 42 is sandwiched between the armature 43 and the plate 46 is released by the reaction of the electromagnetic coil 44, thereby the braking force (holding force) acting on the rotary shaft 21 is released.

The brake 40 of the present embodiment is a non-excitation actuated type brake that is actuated by a biasing force of a spring (not shown) when the electromagnetic coil 44 is not energized, and presses the rotor 42 with the armature 43 to hold the rotary shaft 21 in a stopped state.

### Configuration of Circuit Section

The circuit section 50 is disposed on the counter-output side of the brake 40. The circuit section 50 includes a rotation detection unit 51 that detects the rotation of the rotary shaft 21, as well as a motor driver board on which a drive circuit of the motor 20 is mounted, and an encoder board on which a detection circuit of the rotation detection unit 51 is mounted. These are accommodated in a circuit section casing 52 fixed to the brake casing 48.

### Contact State of Heat Transfer Member

As shown in FIG. 2, the heat transfer member 25 having elasticity is interposed between the coil end 232 of the motor 20 and an adjacent member on the outside thereof in the axial direction. Specifically, a first heat transfer member 25a is disposed between the coil end 232a on the output side and the first speed reducer casing 34A of the speed reducer 30, and a second heat transfer member 25b is disposed between the coil end 232b on the counter-output side and the cover member 61.

More specifically, since each coil end 232 is molded with resin, each heat transfer member 25 is disposed (sandwiched) between the resin-molded coil end 232 (that is, a mold resin for molding the coil end 232) and the first speed reducer casing 34A or the cover member 61.

In addition, each heat transfer member 25 is sandwiched between the coil end 232 and the first speed reducer casing 34A or the cover member 61 in a compressed state (a state in which an axial dimension is reduced) compared to a state before assembly (incorporation of the heat transfer member 25 between the coil end 232 and the first speed reducer casing 34A or the cover member 61). That is, the axial dimension between the coil end 232 and the first speed reducer casing 34A or the cover member 61 is smaller (shorter) than the axial dimension of the heat transfer member 25 before assembly.

The first heat transfer member 25a on the output side is in contact with the first speed reducer casing 34A of the speed reducer 30, and is also in contact with the retaining plate 38 on the inner peripheral side thereof. Note that it is preferable that axial compression (force) of the first heat transfer member 25a between the coil end 232a and the retaining plate 38 is weaker than axial compression (force) of the first heat transfer member 25a between the coil end 232a and the first speed reducer casing 34A. In other words, with respect to a space into which the first heat transfer member 25a is incorporated, it is preferable that the axial dimension between the coil end 232a and the retaining plate 38 is larger (longer) than the axial dimension between the coil end 232a and the first speed reducer casing 34A.

In addition, it is preferable that the first heat transfer member 25a on the output side has higher heat transfer performance than the second heat transfer member 25b on the counter-output side. For this purpose, a member having a higher thermal conductivity than that of the second heat transfer member 25b may be used as the first heat transfer member 25a, or the axial compression of the first heat transfer member 25a may be made stronger than the compression of the second heat transfer member 25b.

The heat transfer member 25 is not particularly limited as long as it has elasticity and a thermal conductivity higher than a thermal conductivity of air (approximately 0.025 W/m·K). For example, various highly thermally conductive resins can be suitably applied. For example, in a case where the heat transfer member 25 is made of epoxy resin or silicone resin, a thermal conductivity of 0.5 to 5.5 W/m·K can be achieved. Accordingly, the heat dissipation can be improved compared to a case where a gap (air) is provided between the coil end 232 and the first speed reducer casing 34A or the cover member 61. The form of the heat transfer member 25 is not particularly limited. For example, a sheet form, a gel form, or other forms can be used. In addition, the heat transfer member 25 may be applied to the coil end 232, attached to the coil end 232, or simply disposed on the coil end 232.

By providing such a heat transfer member 25, heat generated from the motor stator 23 is transmitted to the first speed reducer casing 34A or the cover member 61 through the motor casing 24, and simultaneously with this transmission, the heat is transmitted to the first speed reducer casing 34A or the cover member 61 from each coil end 232 through each heat transfer member 25. Therefore, the heat dissipation of the motor 20 (motor stator 23), particularly the heat dissipation of the coil end 232 can be improved.

In addition, since each heat transfer member 25 has elasticity, the retaining plate 38 and the cover member 61 can be held without applying an excessive load, and strict dimensional control is not required.

### Technical Effects of One Embodiment

As described above, with the actuator 1 of one embodiment, the first heat transfer member 25a having elasticity is disposed between the coil end 232a of the motor 20 and the first speed reducer casing 34A of the speed reducer 30.

Accordingly, heat generated from the coil end 232a is transmitted to the first speed reducer casing 34A through the first heat transfer member 25a. Therefore, unlike the related art in which heat dissipation was performed by the motor alone, the heat dissipation of the motor 20 can be suitably improved by the actuator 1.

Further, since the heat transfer member 25 has elasticity, the heat transfer member 25 can be easily incorporated without requiring strict dimensional control.

In addition, with the actuator 1 of one embodiment, since the first speed reducer casing 34A is connected to the mating member E (via the second speed reducer casing 34B), the heat generated from the coil end 232a is transmitted to the mating member E via the first speed reducer casing 34A.

Accordingly, the heat dissipation of the motor 20 can be further improved.

In addition, with the actuator 1 of one embodiment, the first heat transfer member 25a is sandwiched between the coil end 232a and the first speed reducer casing 34A in a compressed state (a state in which the axial dimension is reduced) compared to a state before assembly.

Accordingly, the effect of the heat transfer from the coil end 232a to the first speed reducer casing 34A through the first heat transfer member 25a can be further improved.

In addition, with the actuator 1 of one embodiment, the first heat transfer member 25a is in contact with the first speed reducer casing 34A and the retaining plate 38 that is disposed on the inner peripheral side of the first speed reducer casing 34A and that restrains the external gear 32A (reduction member) in the axial direction.

Accordingly, the heat generated from the coil end 232a can be transmitted to the first speed reducer casing 34A while the retaining plate 38 is suitably held by the first heat transfer member 25a.

In addition, with the actuator 1 of one embodiment, the axial compression of the first heat transfer member 25a between the coil end 232a and the retaining plate 38 is weaker than the axial compression of the first heat transfer member 25a between the coil end 232a and the first speed reducer casing 34A.

Accordingly, the retaining plate 38 can be favorably held while relatively improving the heat transfer performance of the first heat transfer member 25a to the first speed reducer casing 34A.

In addition, with the actuator 1 of one embodiment, the second heat transfer member 25b having elasticity is disposed between the coil end 232b on the counter-output side and the cover member 61 disposed on the counter-output side of the motor 20.

Accordingly, heat can be dissipated from the coil end 232b on the counter-output side to the cover member 61, thereby further improving the heat dissipation of the motor 20.

In addition, with the actuator 1 of one embodiment, the first heat transfer member 25a on the output side has higher heat transfer performance than the second heat transfer member 25b on the counter-output side.

Accordingly, the heat transfer performance can be improved with respect to the output side to which the mating member E is connected, that is, the side with a larger heat capacity, and thus the heat dissipation of the motor 20 can be further improved.

### Another Embodiment

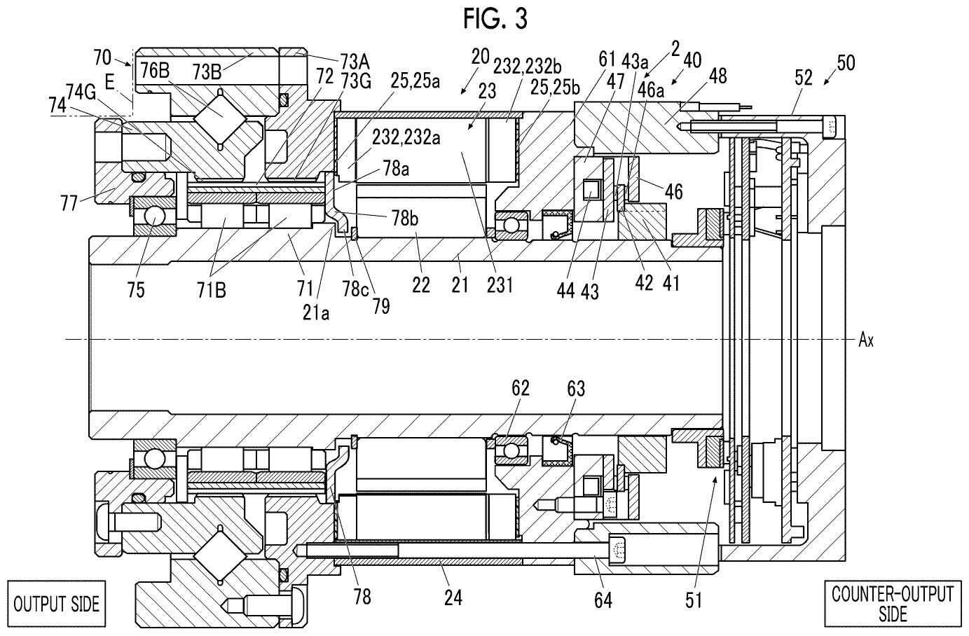

Subsequently, another embodiment of the present invention will be described. FIG. 3 is a cross-sectional view showing an actuator 2 according to another embodiment.

The actuator 2 is different from the actuator 1 of one embodiment in that the actuator 2 includes a bending meshing speed reducer 70 instead of the eccentric oscillating speed reducer 30 in one embodiment. Hereinafter, these differences will be mainly described, and the same components as those in one embodiment will be denoted by the same reference numerals, and the description thereof will be omitted.

As shown in FIG. 3, the speed reducer 70 is a cylindrical bending meshing speed reducer, and is disposed on the output side of the motor 20. Specifically, the speed reducer 70 includes a wave generator 71, an external gear 72, a first internal gear 73G, a second internal gear 74G, a first speed reducer casing 73A, a second speed reducer casing 73B, and an internal gear member 74.

The wave generator 71 is provided on a portion of the rotary shaft 21 that extends into the speed reducer 70, and has a non-circular shape (for example, an elliptical shape) in a cross section perpendicular to the center axis Ax.

The external gear 72 is a flexible cylindrical member centered on the center axis Ax, and has teeth on its outer periphery. The external gear 72 is rotatable relative to the wave generator 71 by a wave generator bearing 71B disposed between the external gear 72 and the wave generator 71, and is flexibly deformed by the rotation of the wave generator 71.

The first internal gear 73G and the second internal gear 74G rotate around the periphery of the wave generator 71 about the center axis Ax. The first internal gear 73G and the second internal gear 74G are arranged in the axial direction and mesh with the external gear 72. The first internal gear 73G and the second internal gear 74G are configured such that internal teeth are provided at the corresponding locations on inner peripheral portions of the first speed reducer casing 73A and the internal gear member 74.

The first speed reducer casing 73A covers the outer peripheral side of the external gear 72. The first speed reducer casing 73A is fastened together with the brake casing 48, the cover member 61, and the motor casing 24 by the fastening screw 64.

The internal gear member 74 is connected to an output member 77 disposed on its output side. The output member 77 rotatably supports the rotary shaft 21 via a bearing 75. The output member 77 is connected to a driven member (not shown).

The second speed reducer casing 73B is disposed on the output side of the first speed reducer casing 73A and is connected to the first speed reducer casing 73A. The second speed reducer casing 73B covers the outer peripheral side of the internal gear member 74 and rotatably supports the internal gear member 74 via a main bearing 76B (for example, a cross roller bearing). The second speed reducer casing 73B is fixed to the mating member E together with the first speed reducer casing 73A.

A retaining plate 78 that restricts movement of the external gear 72 and the wave generator bearing 71B to the counter-output side is disposed on the counter-output side of the external gear 72 and the wave generator bearing 71B.

The retaining plate 78 is configured in the same manner as the retaining plate 38 of one embodiment, and includes a disk portion 78a disposed perpendicularly to the axial direction, a tubular portion 78b extending from an inner peripheral end of the disk portion 78a to the counter-output side, and an extension portion 78c extending from an end of the tubular portion 78b on the counter-output side to the inner peripheral side. An outer periphery of the disk portion 78a is held (or fitted) in the first speed reducer casing 73A, and a surface of the disk portion 78a on the counter-output side is substantially flush with a surface of the first speed reducer casing 73A. The tubular portion 78b has a tapered shape that gradually decreases in diameter from the output side toward the counter-output side. The extension portion 78c has an outer diameter larger than an outer diameter of a stepped portion 21a of the rotary shaft 21 and an inner diameter smaller than the outer diameter of the stepped portion 21a. The stepped portion 21a of the rotary shaft 21 is disposed on the inner peripheral side of the tubular portion 78b and is formed in a stepped shape such that the outer diameter decreases toward the counter-output side. A retaining ring 79 fitted into the circumferential groove of the rotary shaft 21 is disposed on an axially opposite side of the stepped portion 21a across the extension portion 78c.

The tubular portion 78b and the extension portion 78c of the retaining plate 78, the stepped portion 21a of the rotary shaft 21, and the retaining ring 79 constitute a labyrinth seal. Accordingly, as compared with a case where an oil seal is provided in this portion, the motor 20 and the speed reducer 70 can be appropriately sealed with a compact and low-loss configuration, and leakage of a lubricant in the speed reducer 70 can be suppressed.

With such a configuration, in the speed reducer 70, the wave generator 71 that is integrally formed with the rotary shaft 21 also rotates in association with the rotation of the rotary shaft 21 output from the motor 20, and the motion is transmitted to the external gear 72. In this case, the external gear 72 is restricted to a shape that conforms to an outer peripheral surface of the wave generator 71, and is deflected into an elliptical shape when viewed in the axial direction. Further, the external gear 72 meshes with the fixed first internal gear 73G at the long axis portion. Therefore, the external gear 72 does not rotate at the same rotational speed as the wave generator 71, and the wave generator 71 rotates relatively inside the external gear 72. In accordance with this relative rotation, the external gear 72 is flexibly deformed such that the long axis position and the short axis position move in the circumferential direction. A period of the deformation is proportional to a rotation period of the wave generator 71.

When the external gear 72 is flexibly deformed, the long axis position of the external gear 72 moves, so that the position where the external gear 72 and the first internal gear 73G mesh with each other changes in the rotation direction, the external gear 72 rotates, and the speed is reduced at a reduction ratio corresponding to the difference in number of teeth between the external gear 72 and the first internal gear 73G. For example, in a case where the number of teeth of the external gear 72 is 100 and the number of teeth of the first internal gear 73G is 102, the speed is reduced to 1/50. Meanwhile, the external gear 72 meshes with the second internal gear 74G as well, so that the position where the external gear 72 and the second internal gear 74G mesh with each other also changes in the rotation direction by the rotation of the wave generator 71. Here, when the number of teeth of the second internal gear 74G is the same as the number of teeth of the external gear 72, the external gear 72 and the second internal gear 74G do not rotate relative to each other, and the rotating motion of the external gear 72 is transmitted to the second internal gear 74G at a reduction ratio of 1:1. As a result, the rotating motion of the wave generator 71 is decelerated and is transmitted to the internal gear member 74 and the output member 77, and this rotating motion is output to the driven member.

In addition, in the actuator 2 of another embodiment, the first heat transfer member 25a disposed on the coil end 232a of the motor 20 is in contact with the first speed reducer casing 73A and the retaining plate 78 instead of the first speed reducer casing 34A and the retaining plate 38 in one embodiment. As in one embodiment, the retaining plate 78 is held while the heat generated from the coil end 232a is transmitted to the first speed reducer casing 73A.

The actuator 2 of another embodiment configured as described above can also achieve the same effects as those of one embodiment.

### Others

The embodiments of the present invention have been described above, but the present invention is not limited to the above-described embodiments.

For example, in the above-described embodiments, a center crank type eccentric oscillating speed reducer or a cylindrical bending meshing speed reducer is exemplified as the speed reducer. However, the type of the speed reducer according to the present invention is not particularly limited, and may be, for example, a cup type or silk hat type bending meshing speed reducer, a sorting type eccentric oscillating speed reducer, or a simple planetary type speed reducer, and may also be a parallel shaft speed reducer or an orthogonal speed reducer.

In addition, the details described in the above-described embodiments can be appropriately changed without departing from the gist of the invention.

As described above, the present invention is useful for improving the heat dissipation of the motor.

It should be understood that the invention is not limited to the above-described embodiment, but may be modified into various forms on the basis of the spirit of the invention. Additionally, the modifications are included in the scope of the invention.

What is claimed is:

1. An actuator comprising:
a motor and a speed reducer that are connected to each other,
wherein a heat transfer member having elasticity is disposed between a coil end of the motor and a speed reducer casing of the speed reducer.

2. The actuator according to claim 1,
wherein the speed reducer casing is connected to a mating member.

3. The actuator according to claim 1,
wherein the heat transfer member is sandwiched between the coil end and the speed reducer casing in a compressed state compared to a state before assembly.

4. The actuator according to claim 1,
wherein the speed reducer includes a retaining plate that is disposed inside the speed reducer casing and that restricts axial movement of a gear member, and
the heat transfer member is in contact with the speed reducer casing and the retaining plate.

5. The actuator according to claim 4,
wherein compression of the heat transfer member between the coil end and the retaining plate is weaker than compression of the heat transfer member between the coil end and the speed reducer casing.

6. The actuator according to claim 1,
wherein the coil end is molded with resin, and
the heat transfer member is sandwiched between the resin for molding the coil end and the speed reducer casing.

7. The actuator according to claim 1,
wherein the motor includes another coil end on a side opposite to a speed reducer side, and
another heat transfer member having elasticity is disposed between the other coil end and a cover member disposed on a counter-speed reducer side with respect to the coil end.

8. The actuator according to claim 7,
wherein the heat transfer member has higher heat transfer performance than the other heat transfer member.

9. The actuator according to claim 1, further comprising:
a brake disposed on a counter-output side with respect to the motor; and
a circuit section disposed on the counter-output side with respect to the brake.

10. The actuator according to claim 9,
wherein the brake includes a hub member, and a rotor, and
the hub member is fixed to a rotary shaft that extends from the motor to an inside of the brake, and the rotor is connected to the hub member.

11. The actuator according to claim 10,
wherein the brake further includes an armature, a plate, and a frame, and
the armature is disposed on an output side of the rotor and is supported to be displaceable in an axial direction such that the armature comes into contact with and separate from the rotor, and the plate is disposed on a counter-output side of the rotor and is supported by the frame.

12. The actuator according to claim 11,
wherein a movable friction material is provided on a surface of the armature that faces the rotor in the axial direction, and a fixed friction material is provided on a surface of the plate that faces the rotor in the axial direction.

13. The actuator according to claim 12,
wherein the brake further includes an electromagnetic coil, and
the electromagnetic coil moves the armature in the axial direction by a magnetic force generated by energization, and brings the movable friction material into contact with and away from the rotor.

14. The actuator according to claim 9,
wherein the circuit section includes a rotation detection unit that detects a rotation of a rotary shaft.
